(19) United States
(12) Patent Application Publication
(10) Pub. No.: US 2025/0155682 A1
(43) Pub. Date: May 15, 2025

(54) OPTICAL SYSTEM AND IMAGE PICKUP APPARATUS

(71) Applicant: CANON KABUSHIKI KAISHA, Tokyo (JP)

(72) Inventor: Mayu OHHORI, Tochigi (JP)

(21) Appl. No.: 18/931,193

(22) Filed: Oct. 30, 2024

(30) Foreign Application Priority Data
Nov. 9, 2023 (JP) 2023-191325

(51) Int. Cl. G02B 13/00

(52) U.S. Cl. CPC G02B 13/0045; G02B 13/0055

(57) ABSTRACT

An optical system includes a plurality of lenses including a first lens, a second lens, a third lens, a fourth lens, a fifth lens, and a sixth lens arranged in order from an object side to an image side, and an aperture stop disposed between the first lens and the second lens. Predetermined inequalities are satisfied.

### BACKGROUND

### Technical Field

The disclosure relates to an optical system suitable for an image pickup apparatus, etc.

### SUMMARY

An optical system according to one aspect of the disclosure includes a plurality of lenses including a first lens, a second lens, a third lens, a fourth lens, a fifth lens, and a sixth lens arranged in order from an object side to an image side, and an aperture stop disposed between the first lens and the second lens. The following inequalities are satisfied:

−0.59≤S23<0.00

1.50≤f2/f≤3.00

where R2i is a radius of curvature of a surface on the image side of the second lens, R3o is a radius of curvature of a surface on the object side of the third lens, S23=(R2i+R3o)/(R2i−R3o), f is a focal length of the optical system, and f2 is a focal length of the second lens. An image pickup apparatus having the above optical system also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a sectional view of an optical system according to Example 1 (numerical example 1).

FIG. 2 is a longitudinal aberration diagram of numerical example 1.

FIG. 3 is a sectional view of an optical system according to Example 2 (numerical example 2).

FIG. 4 is a longitudinal aberration diagram of numerical example 2.

FIG. 5 is a sectional view of an optical system according to Example 3 (numerical example 3).

FIG. 6 is a longitudinal aberration diagram of numerical example 3.

FIG. 7 is a sectional view of an optical system according to Example 4 (numerical example 4).

FIG. 8 is a longitudinal aberration diagram of numerical example 4.

FIG. 9 is a sectional view of an optical system according to Example 5 (numerical example 5).

FIG. 10 is a longitudinal aberration diagram of numerical example 5.

FIG. 11 is a sectional view of an optical system according to Example 6 (numerical example 6).

FIG. 12 is a longitudinal aberration diagram of numerical example 6.

FIG. 13 illustrates a tapered shape of an edge portion of a lens.

FIG. 14 illustrates a sag amount of a lens.

FIG. 15 is a schematic diagram of an image pickup apparatus using the optical systems according to any one of Examples 1 to 6.

### DETAILED DESCRIPTION

Referring now to the accompanying drawings, a description will be given of embodiments according to the disclosure. Before specific Examples 1 to 6 are described, a description will now be given of matters common to each of examples.

The optical system according to each example is used in various image pickup apparatuses such as digital still cameras, digital video cameras, security cameras, and in-vehicle (on-board) cameras.

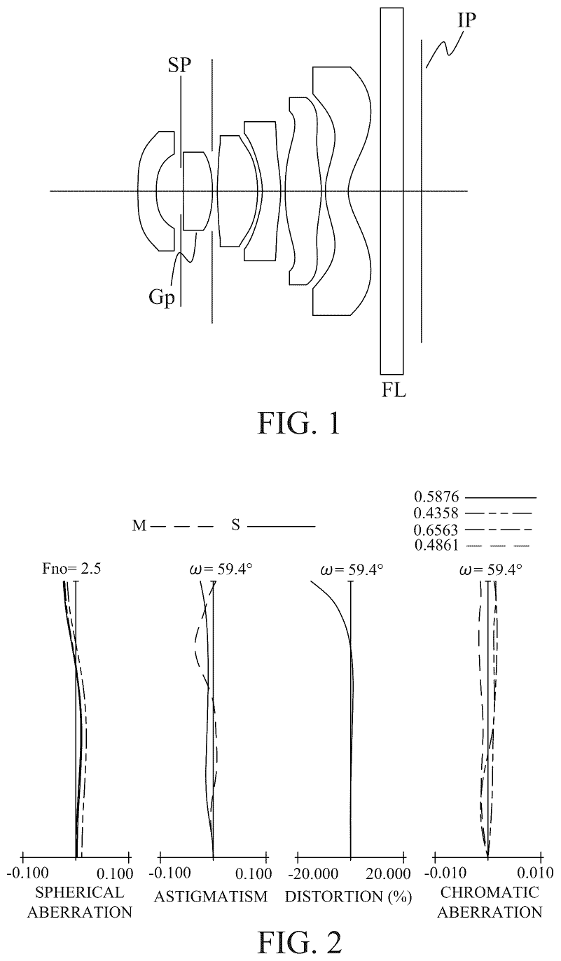

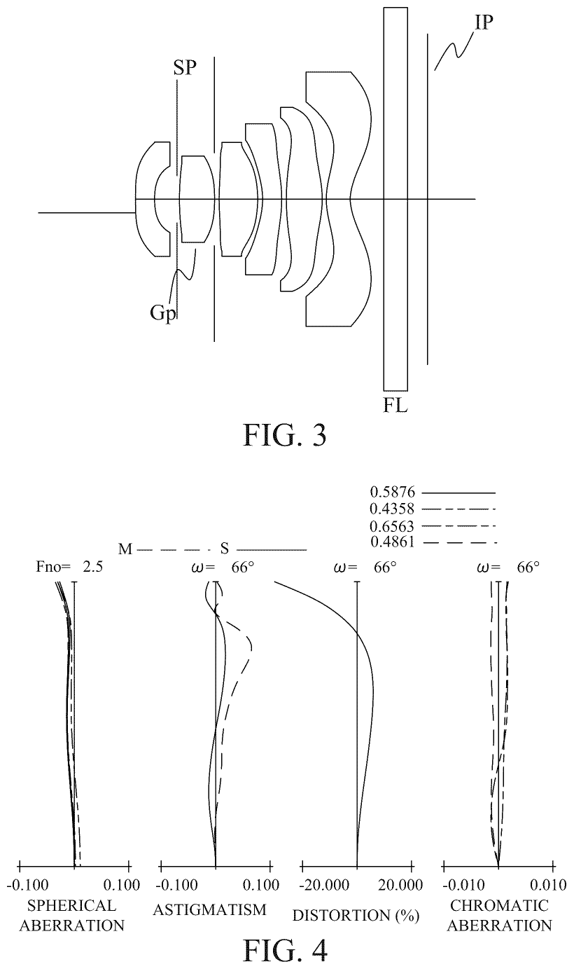

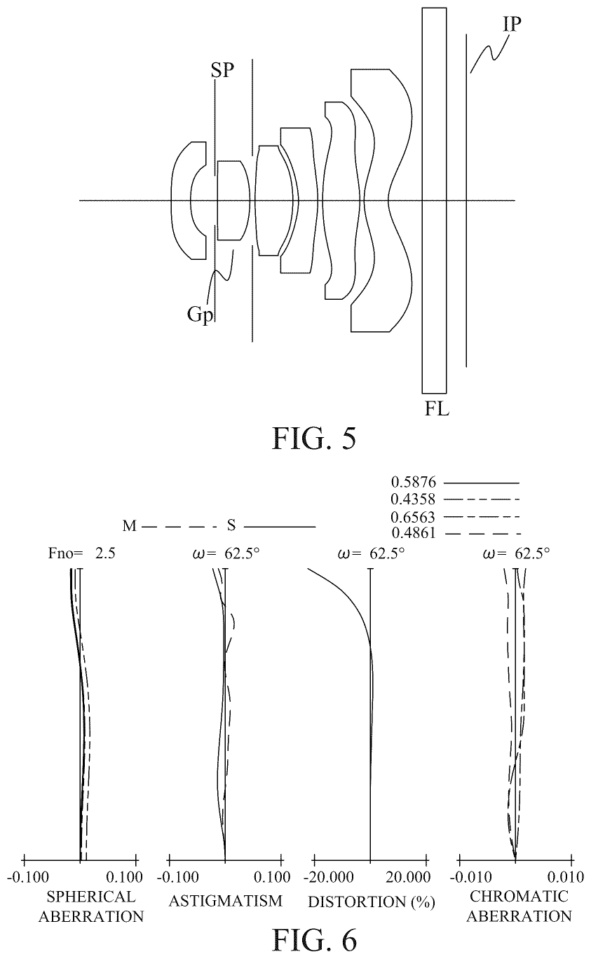

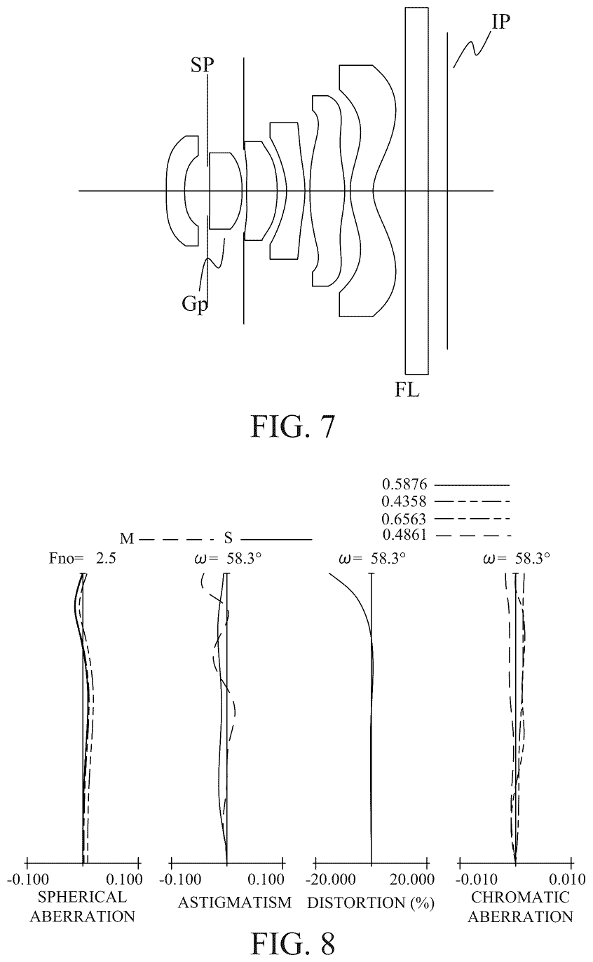

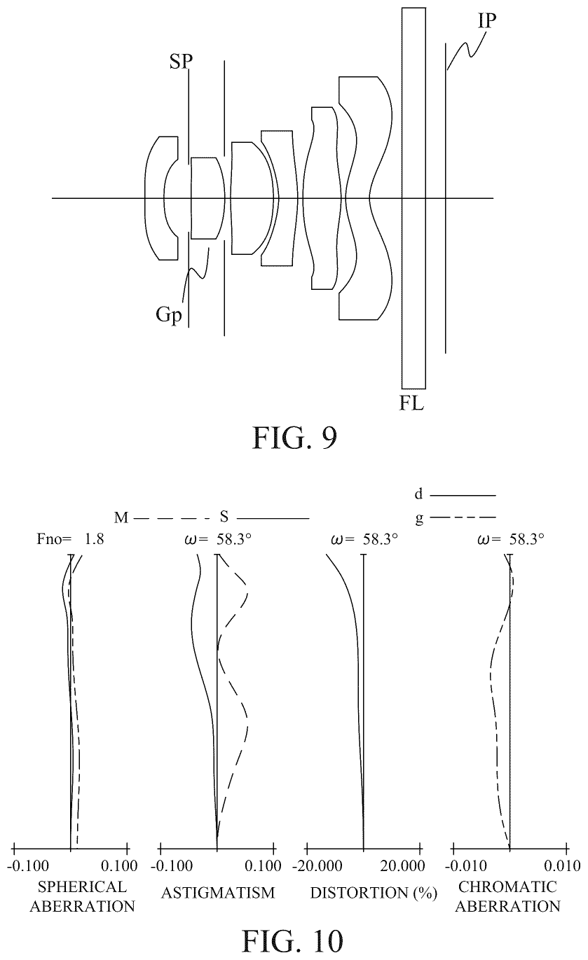

FIGS. 1, 3, 5, 7, 9, and 11 illustrate the configurations of the optical system according to Examples 1 to 6, respectively. In each figure, a left side is an object side, and a right side is an image side. The optical system according to each example includes a plurality of lenses (six or more) including a first lens, a second lens, a third lens, a fourth lens, a fifth lens, and a sixth lens arranged from the object side to the image side. An aperture stop SP is disposed between the first lens and the second lens.

FL represents an optical block, such as an optical filter, a low-pass filter, an infrared cut filter, etc. IP represents an image plane. An imaging surface (light receiving surface) of an image sensor, which is a photoelectric conversion element such as a CCD sensor or a CMOS sensor, or a film plane (photosensitive surface) of a silver film is disposed on the image plane IP.

A description will now be given of the conditions that the optical system according to each example may satisfy.

The following inequalities are satisfied:

$$- 0.59 \leq S 23 < 0. \qquad ( 1 )$$

$$1.5 \leq f 2 / f \leq 3. \qquad ( 2 )$$

where R2i is a radius of curvature of a surface on the image side of the second lens, R3o is a radius of curvature of a surface on the object side of the third lens, and S23=(R2i+R3o)/(R2i−R3o), f is a focal length of the optical system, and f2 is a focal length of the second lens.

Inequality (1) defines a proper relationship between a surface shape on the image side of the second lens and a surface shape on the object side of the third lens. S23 is also called a shape factor of an air lens between the surface on the image side of the second lens and the surface on the object side of the third lens. In a case where the radius of curvature of the surface on the image side of the second lens becomes small so that S23 becomes lower than the lower limit of inequality (1), the edge portion of the second lens becomes locally thin by forming a tapered portion to be engaged with a tapered portion of the third lens. In a case where S23 becomes higher than the upper limit of inequality (1), the radius of curvature of the surface on the image side of the second lens becomes large, the refractive power becomes low, and coma significantly occurs and is difficult to correct. Satisfying inequality (1) can improve the molding stability of the lens (in particular a lens having a tapered portion on its edge portion) disposed near the aperture stop SP and satisfactorily correct coma.

Inequality (2) defines a proper relationship between the on-axis focal length f in the optical system and the focal length f2 of the second lens. In a case where f2/f becomes lower than the lower limit of inequality (2), the refractive power of the second lens increases. In this case, in a case where the lens thickness of the second lens is maintained, the radius of curvature of the lens surface reduces, and the edge portion becomes thinner. In a case where f2/f becomes higher than the upper limit of inequality (2), the refractive power of the second lens reduces. As a result, large spherical aberration occurs and is difficult to correct.

The above configuration satisfying the above conditions can realize an optical system that has a reduced size, a wide angle of view, and high optical performance, and secures the lens molding stability.

The optical system according to each example may satisfy at least one of the following inequalities (3) to (8).

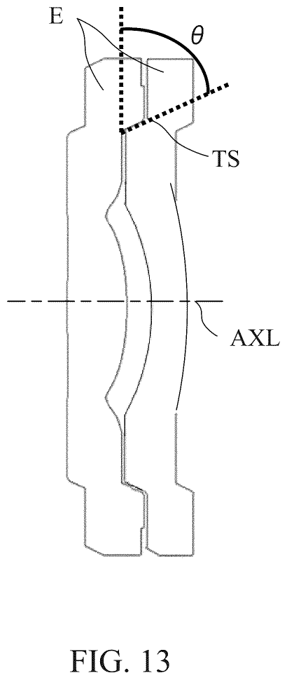

FIG. 13 illustrates a taper angle θ of a lens. In each example, taper portions TS formed on edge portions E of at least two adjacent lenses are brought into contact (engaged) with each other to avoid relative decentering of these lenses. The edge portions E are the end portions of the lenses outside the optical effective diameter, which will be described later. The taper angle θ of the taper portion TS is an angle between the taper portion TS and a plane perpendicular to the central axis (optical axis AXL) of the lens.

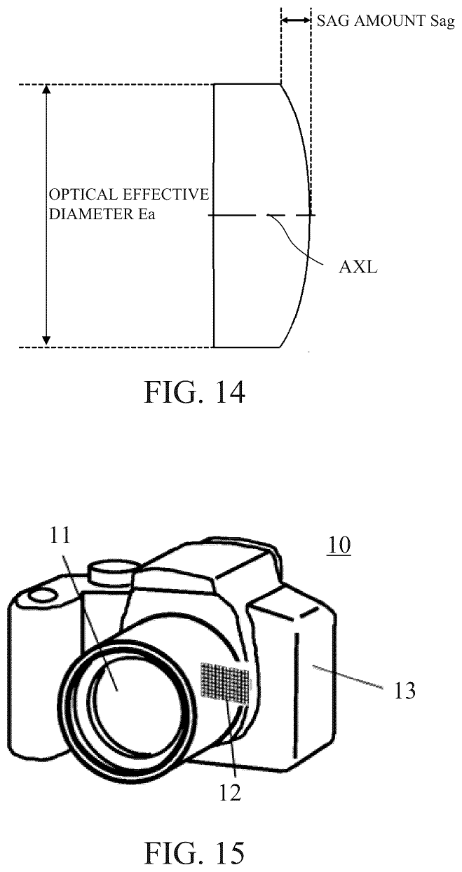

FIG. 14 illustrates a sag amount Sag of a lens. The sag amount Sag is a length in the optical axis direction from a vertex of a lens surface (such as a point on the optical axis AXL) to the point (position) of the optical effective diameter Ea. The optical effective diameter is a radius of the area of the lens surface through which light rays that contribute to imaging pass.

As described above, in a case where the taper portions provided on the edge portions of adjacent lenses contact each other, the following inequality (3) may be satisfied:

$$0. < cos θ \leq 0.77 \qquad ( 3 )$$

where θ is the taper angle of the taper portion relative to the plane perpendicular to the optical axis.

Inequality (3) defines a proper range of the taper angle θ. In a case where θ becomes lower than the lower limit of inequality (3), the taper angle θ becomes 90° or more. As a result, a wedge portion shape is required at the edge portion, and the lens molding stability lowers. In a case where θ becomes higher than the upper limit of inequality (3), the engagement length at the taper portion is reduced, and the lens is likely to tilt relative to the plane perpendicular to the optical axis.

The following inequality (4) may be satisfied:

$$1.66 \leq dE 23 / d 23 \leq 4.56 \qquad ( 4 )$$

where d23 is a distance on the optical axis between the second lens and the third lens, dE23 is a distance in the optical axis direction at the position of the optical effective diameter of each of the second lens and the third lens.

Inequality (4) defines a proper relationship between the distance d23 on the optical axis between the second lens and the third lens and the distance dE23 at the position of the optical effective diameter. In a case where dE23/d23 becomes lower than the lower limit of inequality (4), the curvature of the second or third lens reduces, the refractive power reduces, and the correction of spherical aberration becomes difficult. In a case where dE23/d23 becomes higher than the upper limit of inequality (4), the optical effective diameter becomes large relative to the distance on the optical axis between the second and third lenses. As a result, the thickness of the edge portion becomes large relative to the lens thickness within the optical effective diameter, and the lens thickness becomes thin, and the lens molding stability reduces.

The following inequality (5) may be satisfied:

$$0.4 \leq dE 34 / d 34 \leq 2. \qquad ( 5 )$$

where d34 is a distance on the optical axis between the third lens and the fourth lens, and dE34 is a distance in the optical axis direction at the position of the optical effective diameter of each of the third lens and the fourth lens.

Inequality (5) defines a proper relationship between the distance d34 on the optical axis between the third lens and the fourth lens and the distance dE34 at the position of the optical effective diameter. In a case where dE34/d34 becomes lower than the lower limit of inequality (5), the curvature of the third lens or the fourth lens reduces, the refractive power reduces, and it becomes difficult to correct the distortion. In a case where dE34/d34 becomes higher than the upper limit of inequality (5), the optical effective diameter becomes large relative to the distance on the optical axis between the third and fourth lenses. As a result, the thickness of the edge portion becomes large relative to the lens thickness within the optical effective diameter, the lens thickness becomes thin, and the lens molding stability reduces.

The following inequality (6) may be satisfied:

$$1.31 \leq TTL / ImgH \leq 2.2 \qquad ( 6 )$$

where ImgH is a maximum image height of the optical system, and TTL is an overall length on the optical axis from the surface closest to the object side of the optical system to the image plane.

Inequality (6) defines a proper relationship between the maximum image height ImgH and the overall optical length TTL of the optical system. In a case where TTL/ImgH becomes lower than the lower limit of inequality (6), the overall optical length becomes small relative to the maximum image height, and it becomes difficult to correct aberrations. In a case where TTL/ImgH becomes higher than the upper limit of inequality (6), the overall optical length becomes too large relative to the maximum image height, and it becomes difficult to miniaturize the optical system.

The following inequality (7) may be satisfied:

$$35. 0 \leq vP\_ 2 \leq 65. \qquad ( 7 )$$

where vP_2 is an Abbe number based on the d-line of the positive lens Gp that is disposed closest to the object among lenses disposed on the image side of the aperture stop SP in the plurality of lenses in the optical system.

Inequality (7) defines a proper range of the Abbe number vP_2 of the positive lens Gp. In order to effectively correct longitudinal chromatic aberration, the positive lens Gp may be formed using a low-dispersion material whose vP_2 satisfies inequality (7).

The following inequality (8) may be satisfied:

$$- 0.20 \leq Sag 2 / Ea 2 < 0.00 \qquad ( 8 )$$

where Ea2 is an optical effective diameter of the second lens, and Sag2 is a sag amount of a surface on the image side of the second lens.

Inequality (8) defines a proper relationship between the sag amount Sag2 and the optical effective diameter Ea2 of the second lens. In a case where Sag2/Ea2 becomes lower than the lower limit of inequality (8), the refractive power of the second lens reduces, and it becomes difficult to correct spherical aberration. In a case where Sag2/Ea2 becomes higher than the upper limit of inequality (8), a surface on the image side of the second lens becomes concave, and it becomes difficult to correct spherical aberration and coma.

Inequalities (1) to (8) may be replaced with inequalities (1a) to (8a) below:

$$- 0.56 \leq S 23 \leq - 0 \text{.10} \qquad ( 1 a )$$

$$1.55 \leq f 2 / f \leq 2.80 \qquad ( 2 a )$$

$$0. < cos θ \leq 0. 64 \qquad ( 3 a )$$

$$2. \leq dE 23 / d 23 \leq 4.40 \qquad ( 4 a )$$

$$0.42 \leq dE 34 / d 34 \leq 1.95 \qquad ( 5 a )$$

$$1.6 \leq TTL / ImgH \leq 2.15 \qquad ( 6 a )$$

$$40. \leq vP\_ 2 \leq 6 0. \qquad ( 7 a )$$

$$- 0.1 \; 8 \leq Sag 2 / Ea 2 \leq - 0.05 \qquad ( 8 a )$$

Inequalities (1) to (8) may be replaced with inequalities (1b) to (8b) below:

$$- 0.53 \leq S 23 \leq - 0 \text{.15} \qquad ( 1 b )$$

$$1.6 \leq f 2 / f \leq 2.4 \qquad ( 2 b )$$

$$0.2 \leq cos θ \leq 0. 50 \qquad ( 3 b )$$

$$2.3 \leq dE 23 / d 23 \leq 4.30 \qquad ( 4 b )$$

$$0.44 \leq dE 34 / d 34 \leq 1.9 \qquad ( 5 b )$$

$$1.8 \leq TTL / ImgH \leq 2.1 \qquad ( 6 b )$$

$$50. \leq vP\_ 2 \leq 5 8. \qquad ( 7 b )$$

$$- 0.1 \; 6 \leq Sag 2 / Ea 2 \leq - 0.06 \qquad ( 8 b )$$

Satisfying at least one of inequalities (3) to (8) in addition to inequalities (1) and (2) can more easily realize an optical system that has a reduced size, a wide angle of view, and high optical performance, and secures the lens molding stability.

To further facilitate the realization of this optical system, the plurality of lenses of the optical system may include aspheric lenses that have no refractive power on the axis (at the central portion) (the curvature on the optical axis is infinite) and have refractive power off the axis (at the peripheral portion).

The optical system according to each example may further include an aspheric surface having an inflection point. The inflection point is a point where the sign of the refractive power of the lens changes. For example, at least one of the plurality of lenses may be a resin lens, and at least one of a surface on the object side of the resin lens and a surface on the image side of the resin lens may be an aspheric surface. In particular, a surface on the object side of the final lens disposed closest to the image plane among the plurality of lenses may be formed so that its central portion is convex toward the object side and its peripheral portion is concave toward the object side, and a surface on the image side of the final lens may be formed so that its central portion is concave toward the image side and its peripheral portion is convex toward the image side.

A detailed description will now be given of the optical systems according to Examples 1 to 6.

### Examples 1 to 5

Each of optical systems according to Examples 1 to 5 illustrated in FIGS. 1, 3, 5, 7, and 9 consists of a first lens, an aperture stop SP, a second lens, a third lens, a fourth lens, a fifth lens, and a sixth lens arranged in order from the object side to the image side. The second lens corresponds to the positive lens Gp. The fifth and sixth lenses are resin lenses as aspheric lenses with aspheric surfaces having inflection points on the object side and the image side. A surface on the object side of the sixth lens, which is the final lens, has a convex shape toward the object side at its central portion and a concave shape toward the object side at its peripheral portion, and a surface on the image side of the sixth lens has a concave shape toward the image side at its central portion and a convex shape toward the image side at its peripheral portion.

### Example 6

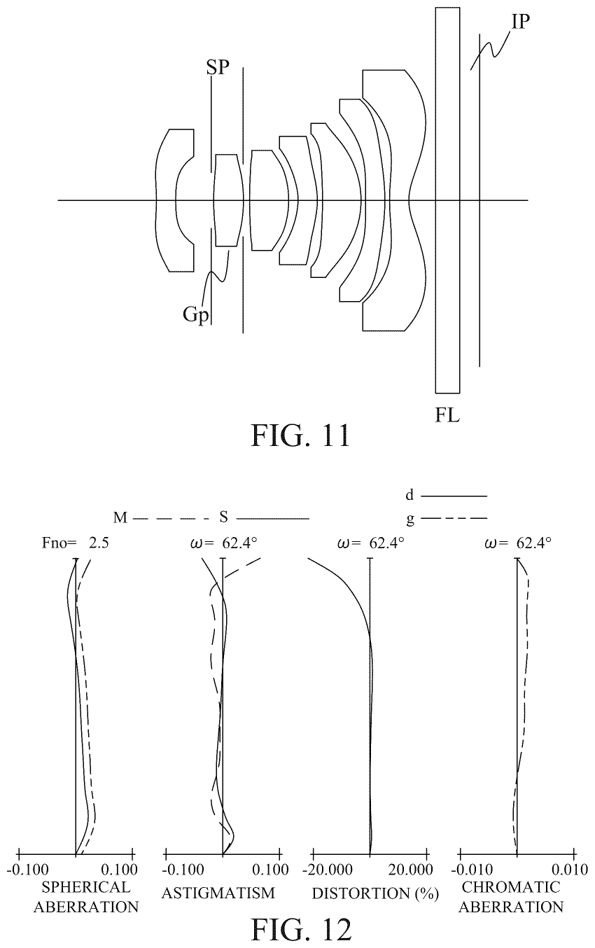

An optical system according to Example 6 illustrated in FIG. 11 consists of a first lens, an aperture stop SP, a second lens, a third lens, a fourth lens, a fifth lens, a sixth lens, and a seventh lens arranged in order from the object side to the image side. The second lens corresponds to the positive lens Gp. The first lens is an aspherical lens with an aspherical surface having an inflection point on the object side, and the seventh lens is an aspherical lens with an aspherical surface having inflection points on the object side and the image side. A surface on the object side of the seventh lens, which is the final lens, has a convex shape toward the object side at its central portion and a concave shape toward the object side at its peripheral portion, and a surface on the image side of the seventh lens has a concave shape toward the image side at its central portion and a convex shape toward the image side at its peripheral portion.

Numerical examples 1 to 6 corresponding to Examples 1 to 6 will be illustrated. In each numerical example, a surface number i represents the order of the surface counted from the object side. r represents a radius of curvature (mm) of an i-th surface from the object side, d represents a lens thickness or air gap (mm) between i-th and (i+1)-th surfaces, and nd represents a refractive index for the d-line of the optical material between the i-th and (i+1)-th surfaces. νd is an Abbe number based on the d-line of the optical material between the i-th and (i+1)-th surfaces. The Abbe number νd based on the d-line is expressed as follows:

$$vd = ( Nd - 1 ) / ( NF - NC )$$

where Nd, NF, and NC are refractive indices for the d-line (587.6 nm), F-line (486.1 nm), and C-line (656.3 nm) in the Fraunhofer lines.

$$X = ( h 2 / R ) / [ 1 + √ \{ 1 - ( 1 + k ) ( h / R ) 2 \} ] 1 / 2 + A 4 \times h 4 + A 6 \times h 6 + A 8 \times h 8 + A 10 \times h 10 + A 12 \times h 12$$

In each numerical example, d, focal length [mm], F-number, and half angle of view [°] are all values in a case where the optical system is in an in-focus state on an object at infinity. BF is a back focus (mm). The back focus is a distance on the optical axis from a lens surface closest to the image plane (final surface) of the optical system to the paraxial image plane, expressed as an air-equivalent length. The overall lens length is a distance on the optical axis from a lens surface closest to the object (foremost surface) of the optical system to the final surface plus the back focus, and corresponds to the overall length TTL in inequality (6).

An asterisk “*” next to the surface number means that that surface has an aspheric shape. The aspheric shape is expressed by the following expression:

$$X = ( {h}^{2} / R ) {/ [ 1 + √ \{ 1 - ( 1 + k ) {( h / R )}^{2} \} ]}^{1 / 2} + A 4 \times {h}^{4} + A 6 \times {h}^{6} + A 8 \times {h}^{8} + A 10 \times {h}^{10} + A 12 \times {h}^{12}$$

where X is a displacement from a surface vertex in the optical axis direction, h is a height from the optical axis in a direction perpendicular to the optical axis, a light traveling direction is set positive, R is a paraxial radius of curvature, K is a conic constant, and A4, A6, A8, A10, and A12 are aspheric coefficients. “e±XX” in the conic constant and aspheric coefficient means “×10^{±XX}.”

Table 1 summarizes values of inequalities (1) to (8) for each numerical example.

FIGS. 2, 4, 6, 8, 10, and 12 respectively illustrate longitudinal aberration (spherical aberration, astigmatism, distortion, and chromatic aberration) of the optical systems according to numerical examples 1 to 6 in an in-focus state on an object at infinity. In the spherical aberration diagrams, Fno indicates an F-number, a solid line indicates a spherical aberration amount for the d-line (wavelength 587.6 nm), and an alternate long and two short dashes line indicates a spherical aberration amount for the g-line (wavelength 435.8 nm). The horizontal axis is a defocus amount, which ranges from −0.100 to +0.100 [mm]. In the astigmatism diagrams, a solid line S indicates an astigmatism amount (curvature of field amount) on a sagittal image plane, and a dashed line M indicates an astigmatism amount on a meridional image plane. The horizontal axis is the same as the spherical aberration.

The distortion diagrams illustrate a distortion amount for the d-line. The horizontal axis ranges from −20.000% to +20.000%. The chromatic aberration diagram illustrates a lateral chromatic aberration amount for the g-line. The horizontal axis ranges from −0.020 mm to +0.020 mm. ω is a half angle of view (°).

NUMERICAL EXAMPLE 1
UNIT: mm
SURFACE DATA

| Surface No. | r | d | nd | vd |
|---|---|---|---|---|
| 1* | 20.191 | 0.40 | 1.53500 | 56.0 |
| 2* | 2.079 | 0.54 | | |
| 3 (SP) | ∞ | (Variable) | | |
| 4* | 15.407 | 0.64 | 1.53500 | 56.0 |
| 5* | −3.228 | (Variable) | | |
| 6 | ∞ | 0.11 | | |
| 7* | 4.903 | 0.88 | 1.53500 | 56.0 |
| 8* | −2.328 | 0.10 | | |
| 9* | −1.441 | 0.40 | 1.67070 | 19.3 |
| 10* | −2.844 | 0.10 | | |
| 11* | 4.626 | 0.79 | 1.53500 | 56.0 |
| 12* | −2.262 | 0.09 | | |
| 13* | 1.433 | 0.50 | 1.67070 | 19.3 |
| 14* | 0.845 | (Variable) | | |
| 15 | ∞ | 0.50 | 1.51633 | 64.1 |
| 16 | ∞ | (Variable) | | |
| Image Plane | ∞ | | | |

ASPHERIC DATA
1st Surface
K = 9.90002e+01 A 4 = 2.69929e−01 A 6 = −2.62395e−01 A 8 = 3.26642e−01
A10 = −2.83439e−01 A12 = 1.57972e−01 A14 = −4.41437e−02 A16 = 3.03934e−03
2nd Surface
K = 3.57596e+00 A 4 = 4.04469e−01 A 6 = −2.95327e−01 A 8 = 5.10817e−01
A10 = 1.58440e+00 A12 = −7.91944e+00 A14 = 1.54251e+01 A16 = −1.08170e+01
4th Surface
K = 0.00000e+00 A 4 = −4.42968e−02 A 6 = 1.95834e−02 A 8 = −1.55123e−01
A10 = −5.40909e−02
5th Surface
K = 0.00000e+00 A 4 = −1.70883e−01 A 6 = 7.37522e−02 A 8 = −9.92577e−02
A10 = 1.34773e−01 A12 = −1.51087e−01
7th Surface
K = 0.00000e+00 A 4 = −1.20111e−01 A 6 = 8.85577e−02 A 8 = −3.04424e−02
A10 = 2.91164e−02 A12 = −1.16655e−02
8th Surface
K = 0.00000e+00 A 4 = 6.45329e−02 A 6 = −2.48897e−01 A 8 = 1.47799e−01
A10 = −1.45545e−02
9th Surface
K = 0.00000e+00 A 4 = 3.26282e−01 A 6 = −2.86700e−01 A 8 = 1.66888e−01
A10 = −4.42501e−02 A12 = 3.79471e−03
10th Surface
K = 0.00000e+00 A 4 = 1.20327e−01 A 6 = −2.60615e−02 A 8 = −3.35844e−03
A10 = 2.18625e−03 A12 = −3.03343e−04
11th Surface
K = 0.00000e+00 A 4 = 5.11198e−02 A 6 = −3.95871e−02 A 8 = 9.72543e−03
A10 = −1.66003e−03
12th Surface
K = 0.00000e+00 A 4 = 1.80852e−01 A 6 = −5.21144e−02 A 8 = 7.15455e−03
A10 = −4.47579e−04
13th Surface
K = −9.27669e−01 A 4 = −1.83614e−01 A 6 = 3.26856e−02 A 8 = −4.27438e−03
A10 = 3.17448e−04
14th Surface
K = −2.72910e+00 A 4 = −9.91445e−02 A 6 = 3.21312e−02 A 8 = −7.34233e−03
A10 = 1.04723e−03 A12 = −8.68265e−05 A14 = 3.16248e−06

VARIOUS DATA

| | |
|---|---|
| Focal Length | 2.30 |
| Fno | 2.50 |
| Half Angle of View (°) | 55.12 |
| Image Height | 3.30 |
| Overall Lens Length | 6.21 |
| BF | 0.41 |

NUMERICAL EXAMPLE 2
UNIT: mm
SURFACE DATA

| Surface No. | r | d | nd | vd |
|---|---|---|---|---|
| 1* | 17.515 | 0.40 | 1.53500 | 56.0 |
| 2* | 1.678 | 0.47 | | |
| 3 (SP) | ∞ | (Variable) | | |
| 4* | 6.366 | 0.74 | 1.53500 | 56.0 |
| 5* | −3.550 | (Variable) | | |
| 6 | ∞ | 0.10 | | |
| 7* | 4.399 | 0.81 | 1.53500 | 56.0 |
| 8* | −2.323 | 0.10 | | |
| 9* | −1.465 | 0.40 | 1.67070 | 19.3 |
| 10* | −2.778 | 0.10 | | |
| 11* | 5.525 | 0.75 | 1.53500 | 56.0 |
| 12* | −2.000 | 0.09 | | |
| 13* | 1.610 | 0.50 | 1.67070 | 19.3 |
| 14* | 0.912 | (Variable) | | |
| 15 | ∞ | 0.50 | 1.51633 | 64.1 |
| 16 | ∞ | (Variable) | | |
| Image Plane | ∞ | | | |

ASPHERIC DATA
1st Surface
K = 9.67841e+01 A 4 = 3.34490e−01 A 6 = −3.10866e−01 A 8 = 3.59136e−01
A10 = −3.18637e−01 A12 = 1.93437e−01 A14 = −6.23518e−02 A16 = 5.52754e−03
2nd Surface
K = 3.63450e+00 A 4 = 4.35880e−01 A 6 = 3.43973e−01 A 8 = −1.19595e+00
A10 = 1.36672e+00 A12 = −2.92109e+00 A14 = 1.80170e+01 A16 = −2.08068e+01
4th Surface
K = 0.00000e+00 A 4 = 2.02238e−02 A 6 = −8.72034e−02 A 8 = 2.34233e−01
A10 = −1.41787e−01
5th Surface
K = 0.00000e+00 A 4 = −2.40854e−01 A 6 = 1.48514e−01 A 8 = −1.08695e−02
A10 = −1.78754e−01 A12 = 1.46635e−01
7th Surface
K = 0.00000e+00 A 4 = −1.96604e−01 A 6 = 1.24591e−01 A 8 = −1.35871e−02
A10 = 1.81806e−02 A12 = −8.74667e−03
8th Surface
K = 0.00000e+00 A 4 = 2.94802e−02 A 6 = −2.14856e−01 A 8 = 1.31962e−01
A10 = 2.03303e−03
9th Surface
K = 0.00000e+00 A 4 = 2.86654e−01 A 6 = −2.09965e−01 A 8 = 1.07292e−01
A10 = −2.07780e−02 A12 = −8.14649e−04
10th Surface
K = 0.00000e+00 A 4 = 9.79067e−02 A 6 = 1.30777e−03 A 8 = −2.06164e−02
A10 = 7.25192e−03 A12 = −1.02729e−03
11th Surface
K = 0.00000e+00 A 4 = 2.95807e−02 A 6 = −3.94769e−02 A 8 = 8.36568e−03
A10 = −1.32300e−03
12th Surface
K = 0.00000e+00 A 4 = 1.83636e−01 A 6 = −5.50412e−02 A 8 = 7.34860e−03
A10 = −4.13531e−04
13th Surface
K = −8.86595e−01 A 4 = −1.90092e−01 A 6 = 3.55751e−02 A 8 = −5.23180e−03
A10 = 4.05644e−04
14th Surface
K = −2.92138e+00 A 4 = −1.02409e−01 A 6 = 3.44602e−02 A 8 = −8.15530e−03
A10 = 1.20272e−03 A12 = −1.03365e−04 A14 = 3.95304e−06

VARIOUS DATA

| | |
|---|---|
| Focal Length | 2.19 |
| Fno | 2.50 |
| Half Angle of View (°) | 57.54 |
| Image Height | 3.45 |
| Overall Lens Length | 6.10 |
| BF | 0.40 |

NUMERICAL EXAMPLE 3
UNIT: mm
SURFACE DATA

| Surface No. | r | d | nd | vd |
|---|---|---|---|---|
| 1* | 25.798 | 0.40 | 1.53500 | 56.0 |
| 2* | 2.030 | 0.50 | | |
| 3 (SP) | ∞ | (Variable) | | |
| 4* | 11.821 | 0.67 | 1.53500 | 56.0 |
| 5* | −3.019 | (Variable) | | |
| 6 | ∞ | 0.06 | | |
| 7* | 4.853 | 0.78 | 1.53500 | 56.0 |
| 8* | −2.374 | 0.12 | | |
| 9* | −1.429 | 0.40 | 1.67070 | 19.3 |
| 10* | −2.800 | 0.10 | | |
| 11* | 5.161 | 0.77 | 1.53500 | 56.0 |
| 12* | −2.235 | 0.09 | | |
| 13* | 1.446 | 0.50 | 1.67070 | 19.3 |
| 14* | 0.851 | (Variable) | | |
| 15 | ∞ | 0.50 | 1.51633 | 64.1 |
| 16 | ∞ | (Variable) | | |
| Image Plane | ∞ | | | |

ASPHERIC DATA
1st Surface
K = 9.89999e+01 A 4 = 2.96570e−01 A 6 = −2.74326e−01 A 8 = 3.33396e−01
A10 = −2.85924e−01 A12 = 1.58728e−01 A14 = −4.06374e−02 A16 = 1.03894e−03
2nd Surface
K = 4.51982e+00 A 4 = 4.32042e−01 A 6 = −2.20712e−01 A 8 = 4.27436e−01
A10 = 1.31593e+00 A12 = −7.15287e+00 A14 = 1.65575e+01 A16 = −1.29020e+01
4th Surface
K = 0.00000e+00 A 4 = −4.43698e−02 A 6 = −1.36464e−02 A 8 = −5.31461e−02
A10 = −2.55892e−01
5th Surface
K = 0.00000e+00 A 4 = −2.14168e−01 A 6 = 9.47346e−02 A 8 = −9.82462e−02
A10 = 1.34655e−01 A12 = −1.97190e−01
7th Surface
K = 0.00000e+00 A 4 = −1.40585e−01 A 6 = 1.11879e−01 A 8 = −1.44115e−02
A10 = 2.91427e−02 A12 = −1.83949e−02
8th Surface
K = 0.00000e+00 A 4 = 5.58113e−02 A 6 = −2.51752e−01 A 8 = 1.55751e−01
A10 = 3.81027e−05
9th Surface
K = 0.00000e+00 A 4 = 3.08237e−01 A 6 = −2.87325e−01 A 8 = 1.67972e−01
A10 = −4.05462e−02 A12 = −9.04188e−04
10th Surface
K = 0.00000e+00 A 4 = 1.20140e−01 A 6 = −2.79746e−02 A 8 = −3.54032e−03
A10 = 2.08016e−03 A12 = −3.56861e−04
11th Surface
K = 0.00000e+00 A 4 = 5.21962e−02 A 6 = −4.07358e−02 A 8 = 1.02293e−02
A10 = −1.78847e−03
12th Surface
K = 0.00000e+00 A 4 = 1.83311e−01 A 6 = −5.30339e−02 A 8 = 7.26012e−03
A10 = −4.55350e−04
13th Surface
K = −8.93058e−01 A 4 = −1.81266e−01 A 6 = 3.26088e−02 A 8 = −4.15078e−03
A10 = 2.76107e−04
14th Surface
K = −2.74514e+00 A 4 = −9.92078e−02 A 6 = 3.22442e−02 A 8 = −7.37018e−03
A10 = 1.04751e−03 A12 = −8.66091e−05 A14 = 3.15905e−06

VARIOUS DATA

| | |
|---|---|
| Focal Length | 2.30 |
| Fno | 2.50 |
| Half Angle of View (°) | 56.31 |
| Image Height | 3.45 |
| Overall Lens Length | 6.11 |
| BF | 0.41 |

NUMERICAL EXAMPLE 4
UNIT: mm
SURFACE DATA

| Surface No. | r | d | nd | vd |
|---|---|---|---|---|
| 1* | 27.285 | 0.40 | 1.53500 | 56.0 |
| 2* | 2.771 | 0.50 | | |
| 3 (SP) | ∞ | (Variable) | | |
| 4* | 32.282 | 0.71 | 1.53500 | 56.0 |
| 5* | −2.637 | (Variable) | | |
| 6 | ∞ | 0.06 | | |
| 7* | 6.982 | 0.67 | 1.53500 | 56.0 |
| 8* | −2.680 | 0.21 | | |
| 9* | −1.297 | 0.40 | 1.67070 | 19.3 |
| 10* | −2.288 | 0.11 | | |
| 11* | 6.045 | 0.76 | 1.53500 | 56.0 |
| 12* | −2.160 | 0.12 | | |
| 13* | 1.508 | 0.50 | 1.67070 | 19.3 |
| 14* | 0.861 | (Variable) | | |
| 15 | ∞ | 0.50 | 1.51633 | 64.1 |
| 16 | ∞ | (Variable) | | |
| Image Plane | ∞ | | | |

ASPHERIC DATA
1st Surface
K = 9.90091e+01 A 4 = 2.74957e−01 A 6 = −2.13253e−01 A 8 = 2.07576e−01
A10 = −1.03873e−01 A12 = 1.36720e−03 A14 = 3.48376e−02 A16 = −1.32523e−02
2nd Surface
K = 9.88411e+00 A 4 = 4.21547e−01 A 6 = −2.23705e−01 A 8 = −4.50773e−01
A10 = 4.44887e+00 A12 = −1.24000e+01 A14 = 1.87107e+01 A16 = −1.13162e+01
4th Surface
K = 0.00000e+00 A 4 = −4.77872e−02 A 6 = −2.69298e−01 A 8 = 9.53964e−01
A10 = −1.77358e+00
5th Surface
K = 0.00000e+00 A 4 = −3.41695e−01 A 6 = 2.51110e−01 A 8 = −2.35164e−01
A10 = 2.89013e−01 A12 = −3.02640e−01
7th Surface
K = 0.00000e+00 A 4 = −2.81367e−01 A 6 = 1.55669e−01 A 8 = −4.50000e−02
A10 = 1.27961e−01 A12 = −6.29497e−02
8th Surface
K = 0.00000e+00 A 4 = −1.78289e−02 A 6 = −1.83697e−01 A 8 = 2.24181e−02
A10 = 7.72461e−02
9th Surface
K = 0.00000e+00 A 4 = 3.46661e−01 A 6 = −2.18654e−01 A 8 = 1.40550e−03
A10 = 9.53493e−02 A12 = −2.71074e−02
10th Surface
K = 0.00000e+00 A 4 = 1.65416e−01 A 6 = −3.93858e−02 A 8 = −2.04161e−02
A10 = 1.62875e−02 A12 = −3.15256e−03
11th Surface
K = 0.00000e+00 A 4 = 5.82279e−02 A 6 = −4.12553e−02 A 8 = 1.07833e−02
A10 = −1.84058e−03
12th Surface
K = 0.00000e+00 A 4 = 1.92018e−01 A 6 = −5.31327e−02 A 8 = 7.13338e−03
A10 = −3.84994e−04
13th Surface
K = −7.99601e−01 A 4 = −1.68649e−01 A 6 = 3.35701e−02 A 8 = −4.98014e−03
A10 = 3.13064e−04
14th Surface
K = −2.86337e+00 A 4 = −9.36456e−02 A 6 = 3.11706e−02 A 8 = −7.33434e−03
A10 = 1.07299e−03 A12 = −9.16239e−05 A14 = 3.41945e−06

VARIOUS DATA

| | |
|---|---|
| Focal Length | 2.50 |
| Fno | 2.50 |
| Half Angle of View (°) | 54.07 |
| Image Height | 3.45 |
| Overall Lens Length | 6.13 |
| BF | 0.41 |

NUMERICAL EXAMPLE 5
UNIT: mm
SURFACE DATA

| Surface No. | r | d | nd | vd |
|---|---|---|---|---|
| 1* | −28.113 | 0.40 | 1.53500 | 56.0 |
| 2* | 2.708 | 0.52 | | |
| 3 (SP) | ∞ | 0.05 | | |
| 4* | 12.454 | 0.71 | 1.53500 | 56.0 |
| 5* | −3.149 | −0.01 | | |
| 6 | ∞ | 0.13 | | |
| 7* | 4.994 | 0.90 | 1.53500 | 56.0 |
| 8* | −2.490 | 0.11 | | |
| 9* | −1.454 | 0.40 | 1.67070 | 19.3 |
| 10* | −3.158 | 0.11 | | |
| 11* | 4.751 | 0.80 | 1.53500 | 56.0 |
| 12* | −2.288 | 0.10 | | |
| 13* | 1.404 | 0.50 | 1.67070 | 19.3 |
| 14* | 0.881 | (Variable) | | |
| 15 | ∞ | 0.50 | 1.51633 | 64.1 |
| 16 | ∞ | (Variable) | | |
| Image Plane | ∞ | | | |

ASPHERIC DATA
1st Surface
K = −9.90000e+01 A 4 = 2.44842e−01 A 6 = −2.49793e−01 A 8 = 3.07521e−01
A10 = −2.70426e−01 A12 = 1.45740e−01 A14 = −4.17283e−02 A16 = 4.62671e−03
2nd Surface
K = 2.58517e+00 A 4 = 3.77741e−01 A 6 = −3.27268e−01 A 8 = 6.17591e−01
A10 = 9.02188e−01 A12 = −5.88191e+00 A14 = 9.63382e+00 A16 = −5.23792e+00
4th Surface
K = 0.00000e+00 A 4 = −2.95271e−02 A 6 = −4.40647e−02 A 8 = −4.39331e−02
A10 = 2.39323e−02
5th Surface
K = 0.00000e+00 A 4 = −1.72101e−01 A 6 = 1.11261e−01 A 8 = −5.04755e−02
A10 = −1.24475e−01 A12 = 1.26349e−01
7th Surface
K = 0.00000e+00 A 4 = −1.32679e−01 A 6 = 1.07538e−01 A 8 = −6.98770e−02
A10 = 2.44056e−02 A12 = −3.03499e−03
8th Surface
K = 0.00000e+00 A 4 = 7.10477e−02 A 6 = −2.47000e−01 A 8 = 1.41996e−01
A10 = −3.23519e−02
9th Surface
K = 0.00000e+00 A 4 = 3.08539e−01 A 6 = −2.73380e−01 A 8 = 1.58813e−01
A10 = −4.59732e−02 A12 = 4.58404e−03
10th Surface
K = 0.00000e+00 A 4 = 9.49834e−02 A 6 = −2.36609e−02 A 8 = −6.77300e−04
A10 = 2.35794e−03 A12 = −5.37719e−04
11th Surface
K = 0.00000e+00 A 4 = 6.23075e−02 A 6 = −4.25202e−02 A 8 = 1.03858e−02
A10 = −1.91516e−03
12th Surface
K = 0.00000e+00 A 4 = 1.87618e−01 A 6 = −5.52500e−02 A 8 = 7.35950e−03
A10 = −4.29992e−04
13th Surface
K = −9.08692e−01 A 4 = −1.78329e−01 A 6 = 3.14907e−02 A 8 = −4.44126e−03
A10 = 3.22297e−04
14th Surface
K = −2.87538e+00 A 4 = −9.73192e−02 A 6 = 3.19685e−02 A 8 = −7.30878e−03
A10 = 1.04469e−03 A12 = −8.75248e−05 A14 = 3.21185e−06

VARIOUS DATA

| | |
|---|---|
| Focal Length | 2.30 |
| FNO 1 | 1.80 |
| Half Angle of View (°) | 54.72 |
| Image Height | 3.25 |
| Overall Lens Length | 6.31 |
| BF | 0.41 |

NUMERICAL EXAMPLE 6
UNIT: mm
SURFACE DATA

| Surface No. | r | d | nd | vd |
|---|---|---|---|---|
| 1* | −3.391 | 0.40 | 1.53500 | 56.0 |
| 2* | 4.467 | 0.74 | | |
| 3 (SP) | ∞ | 0.05 | | |
| 4* | 5.190 | 0.62 | 1.53500 | 56.0 |
| 5* | −3.124 | −0.01 | | |
| 6 | ∞ | 0.13 | | |
| 7* | 10.000 | 0.81 | 1.53500 | 56.0 |
| 8* | −1.782 | 0.20 | | |
| 9* | −1.173 | 0.40 | 1.67070 | 19.3 |
| 10* | −1.712 | 0.11 | | |
| 11* | −7.867 | 0.80 | 1.53500 | 56.0 |
| 12* | −1.835 | 0.10 | | |
| 13* | 142.205 | 0.40 | 1.63560 | 23.9 |
| 14* | −3.618 | 0.10 | | |
| 15* | 4.298 | 0.40 | 1.67070 | 19.3 |
| 16* | 1.009 | (Variable) | | |
| 17 | ∞ | 0.50 | 1.51633 | 64.1 |
| 18 | ∞ | (Variable) | | |
| Image Plane | ∞ | | | |

ASPHERIC DATA
1st Surface
K = −2.85341e+01 A 4 = 3.03177e−01 A 6 = −3.20876e−01 A 8 = 2.97182e−01
A10 = −1.96677e−01 A12 = 8.52122e−02 A14 = −2.12615e−02 A16 = 2.22315e−03
2nd Surface
K = −1.68364e+02 A 4 = 6.83211e−01 A 6 = −6.35808e−01 A 8 = 5.15567e−01
A10 = 6.79769e−01 A12 = −2.63820e+00 A14 = 3.72581e+00 A16 = −1.96605e+00
4th Surface
K = 0.00000e+00 A 4 = 1.82483e−02 A 6 = −2.87274e−01 A 8 = 7.53900e−01
A10 = −7.66303e−01
5th Surface
K = 0.00000e+00 A 4 = 4.98478e−02 A 6 = −4.48516e−01 A 8 = 7.17536e−01
A10 = −2.20127e−01 A12 = −8.46379e−02
7th Surface
K = 0.00000e+00 A 4 = 6.48390e−02 A 6 = −3.19105e−01 A 8 = 3.42700e−01
A10 = 2.71052e−02 A12 = −8.43733e−02
8th Surface
K = 0.00000e+00 A 4 = 1.12560e−01 A 6 = −2.11901e−01 A 8 = −5.04672e−02
A10 = 1.29264e−01
9th Surface
K = 0.00000e+00 A 4 = 3.88130e−01 A 6 = −2.80342e−01 A 8 = 4.60709e−02
A10 = 1.02443e−01 A12 = −2.54533e−02
10th Surface
K = 0.00000e+00 A 4 = 2.16787e−01 A 6 = −6.12781e−02 A 8 = 2.03115e−03
A10 = 4.08690e−03 A12 = −9.45404e−04
11th Surface
K = 0.00000e+00 A 4 = 6.44323e−02 A 6 = −6.02014e−02 A 8 = 5.28765e−03
A10 = 5.71006e−05
12th Surface
K = 0.00000e+00 A 4 = 2.23087e−02 A 6 = −7.59855e−03 A 8 = −3.71058e−03
A10 = 3.10301e−03
13th Surface
K = −6.46661e+23 A 4 = −1.23483e−01 A 6 = 4.31916e−02 A 8 = −7.76464e−03
A10 = −4.30659e−04 A12 = 2.62888e−04
14th Surface
K = −5.10184e+01 A 4 = −2.22487e−02 A 6 = 2.01134e−02 A 8 = −8.72629e−03
A10 = 1.51142e−03 A12 = −1.09551e−04
15th Surface
K = 1.04774e+00 A 4 = −1.09534e−01 A 6 = 2.12363e−02 A 8 = −2.82349e−03
A10 = 1.76150e−04 A12 = −5.94746e−06
16th Surface
K = −4.30910e+00 A 4 = −8.63616e−02 A 6 = 3.03324e−02 A 8 = −7.21624e−03
A10 = 1.01020e−03 A12 = −7.75406e−05 A14 =2.52645e−06

VARIOUS DATA

| | |
|---|---|
| ZOOM RATIO | 1.00 |
| Focal Length | 2.30 |
| Fno | 2.50 |
| Half Angle of View (°) | 56.31 |
| Image Height | 3.45 |
| Overall Lens Length | 6.71 |
| BF | 0.41 |

TABLE 1

| | NUMERICAL EXAMPLE | | | | | |
|---|---|---|---|---|---|---|
| INEQUALITY | 1 | 2 | 3 | 4 | 5 | 6 |
| 2ω | 150.4 | 160.4 | 160.0 | 133.4 | 159.0 | 133.0 |
| (1)S23 | −0.18 | −0.11 | −0.23 | −0.45 | −0.23 | −0.52 |
| (2)f2/f | 2.30 | 2.00 | 1.99 | 1.84 | 2.08 | 1.63 |
| (3)cosθ | 0.40 | 0.40 | 0.40 | 0.40 | 0.40 | 0.40 |
| (4)dE23/d23 | 3.44 | 4.28 | 3.85 | 3.44 | 2.72 | 2.46 |
| (5)dE34/d34 | 1.04 | 0.82 | 0.45 | 0.87 | 1.86 | 0.81 |
| (6)TTL/ImgH | 1.91 | 1.85 | 1.85 | 1.85 | 1.91 | 2.03 |
| (7)νP_2 | 56.00 | 56.00 | 56.00 | 56.00 | 56.00 | 56.00 |
| (8)Sag2/Ea2 | −0.12 | −0.12 | −0.12 | −0.15 | −0.11 | −0.08 |

### Image Pickup Apparatus

FIG. 15 illustrates a digital still camera (image pickup apparatus) that uses the optical system according to any one of Examples 1 to 6 as an imaging optical system. In a camera 10, reference numeral 13 denotes a camera body, and reference numeral 11 denotes an imaging optical system including one of the optical systems according to Examples 1 to 6. Reference numeral 12 denotes an image sensor such as a CCD sensor or CMOS sensor that is built into the camera body 13 and receives an object image formed by the imaging optical system 11 (images the object).

By using an imaging optical system including one of the optical systems according to Examples 1 to 6, a compact camera that can capture an image with a wide angle of view and good quality can be realized.

The optical system according to each example is not limited to the camera 10 illustrated in FIG. 15, but is applicable to various image pickup apparatus such as digital video cameras and film-based cameras. The camera may be an integrated lens type or a lens interchangeable type, and may be a single-lens reflex camera or a mirrorless camera.

While the disclosure has described example embodiments, it is to be understood that some embodiments are not limited to the disclosed embodiments. The scope of the following claims is to be accorded the broadest interpretation so as to encompass all such modifications and equivalent structures and functions.

Each example can provide an optical system that can secure the lens forming stability and have reduced size and a wide angle of view.

This application claims priority to Japanese Patent Application No. 2023-191325, which was filed on Nov. 9, 2023, and which is hereby incorporated by reference herein in its entirety.

What is claimed is:

1. An optical system comprising:
a plurality of lenses including a first lens, a second lens, a third lens, a fourth lens, a fifth lens, and a sixth lens arranged in order from an object side to an image side; and
an aperture stop disposed between the first lens and the second lens,
wherein the following inequalities are satisfied:
$$- 0.59 \leq S 23 < 0 \text{.00}$$
$$1.5 \leq f 2 / f \leq 3.$$
where R2i is a radius of curvature of a surface on the image side of the second lens, R3o is a radius of curvature of a surface on the object side of the third lens, S23=(R2i+R3o)/(R2i−R3o), f is a focal length of the optical system, and f2 is a focal length of the second lens.

2. The optical system according to claim 1, wherein in a case where the tapered portions provided on edge portions of adjacent lenses in the plurality of lenses contact each other, the following inequality is satisfied:
$$0. < cos θ \leq 0. 77$$
where θ is a taper angle between each tapered portion and a plane perpendicular to an optical axis.

3. The optical system according to claim 1, wherein the following inequality is satisfied:
$$1. 66 \leq dE 23 / d 23 \leq 4.56$$
where d23 is a distance between the second lens and the third lens on an optical axis, and dE23 is a distance between the second lens and the third lens at positions of optical effective diameters in an optical axis direction.

4. The optical system according to claim 1, wherein the following inequality is satisfied:
$$0. 40 \leq dE 34 / d 34 \leq 2.00$$
where d34 is a distance on an optical axis between the third lens and the fourth lens, and dE34 is a distance in an optical axis direction at a position of an optical effective diameter of each of the third lens and the fourth lens.

5. The optical system according to claim 1, wherein the following inequality is satisfied:
$$1. 31 \leq TTL / ImgH \leq 2.2$$
where ImgH is a maximum image height of the optical system, and TTL is an overall length on an optical axis from a surface of the optical system closest to an object to an image plane.

6. The optical system according to claim 1, wherein the following inequality is satisfied:
$$35. 0 \leq vP\_ 2 \leq 65.$$
where vP_2 is an Abbe number based on d-line of a positive lens closest to an object among lenses disposed on the image side of the aperture stop in the plurality of lenses.

7. The optical system according to claim 6, wherein the second lens is the positive lens.

8. The optical system according to claim 1, wherein the following inequality is satisfied:
$$- 0.20 \leq Sag 2 / Ea 2 < 0.00$$
where Ea2 is an effective optical diameter of the second lens, and Sag2 is a sag amount of a surface on the image side of the second lens.

9. The optical system according to claim 1, wherein at least one of the plurality of lenses is a resin lens, and at least one of a surface on the object side of the resin lens and a surface on the image side of the resin lens has an aspheric shape.

10. The optical system according to claim 1, wherein a surface on the object side of a final lens disposed closest to an image plane among the plurality of lenses has a central portion that is convex toward the object side and a peripheral portion that is concave toward the object side, and
wherein a surface on the image side of the final lens has a central portion that is concave toward the image side and a peripheral portion that is convex toward the image side.

11. The optical system according to claim 1, wherein the optical system consists of, in order from the object side to the image side, the first lens, the aperture stop, the second lens, the third lens, the fourth lens, the fifth lens, and a sixth lens as a final lens.

12. The optical system according to claim 1, wherein the optical system consists of, in order from the object side to the image side, the first lens, the aperture stop, the second lens, the third lens, the fourth lens, the fifth lens, a sixth lens, and a seventh lens as a final lens.

13. An image pickup apparatus comprising:
an optical system; and
an image sensor configured to image an object through the optical system,
wherein the optical system includes:
a plurality of lenses including a first lens, a second lens, a third lens, a fourth lens, a fifth lens, and a sixth lens arranged in order from an object side to an image side; and
an aperture stop disposed between the first lens and the second lens,
wherein the following inequalities are satisfied:
$$- 0.59 \leq S 23 < 0 \text{.00}$$
$$1.5 \leq f 2 / f \leq 3.$$
where R2i is a radius of curvature of a surface on the image side of the second lens, R3o is a radius of curvature of a surface on the object side of the third lens, S23=(R2i+R3o)/(R2i−R3o), f is a focal length of the optical system, and f2 is a focal length of the second lens.
